(19) United States
(12) Patent Application Publication
(10) Pub. No.: US 2012/0297399 A1
(43) Pub. Date: Nov. 22, 2012

(54) AUTOMATICALLY UPDATING THE DISPLAY STATE OF THE USER INTERFACE OF A CLIENT DEVICE IN A PUBLISH/SUBSCRIBE SYSTEM

(75) Inventors: Michael B. Beaver, Raleigh, NC (US); Jonathan D. Costello, Durham, NC (US); Jason R. Gary, Clermont, FL (US); Ravi Shah, Laveen, AZ (US)

(73) Assignee: INTERNATIONAL BUSINESS MACHINES CORPORATION, Armonk, NY (US)

(21) Appl. No.: 13/110,717

(22) Filed: May 18, 2011

(51) Int. Cl. G06F 9/44

(52) U.S. Cl. 719/318

(57) ABSTRACT

A method, system and computer program product for updating the display state of the user interface of a subscriber client. A macro component definition file is inspected to obtain the listing of events associated with each macro component listed in the macro component definition file. An event callback function is created for each macro component listed in the macro component definition file, where the callback function will update the displayed user interface of the subscriber client to be the display state of the macro component when one its associated events is published by the publisher. Upon detecting a published event, the event callback function associated with the published event is executed thereby automatically updating the display state of the user interface of the subscriber client to be the display state of the macro component associated with the published event.

### TECHNICAL FIELD

The present invention relates to publish/subscribe systems, and more particularly to automatically updating the display state of the user interface of a client device in a publish/subscribe system.

### BACKGROUND

A publish/subscribe system is an effective way of disseminating information from “publishers” to multiple users or “subscribers.” A publisher generates messages, also referred to as events, which contain a topic and some data content. A subscriber, also referred to herein as a “client,” provides, ahead of time, a criterion, also referred to as a subscription, that specifies the information, based on published messages, that the system is required to deliver to that subscriber client in the future. In a publish/subscribe system, publishers and subscribers are anonymous in that publishers do not necessarily know the number of subscribers or their locations; and subscribers do not necessarily know the locations of the publishers.

In the publish/subscribe system, subscribers typically receive only a subset of the total messages published. The messages may be selected for reception and processing using topic-based or content-based filtering. In a topic-based system, messages are published to “topics” or named logical channels. Subscribers in a topic-based system will receive all messages published to the topics to which they subscribe, and all subscribers to a topic will receive the same message. The publisher is responsible for defining the classes of messages to which subscribers can subscribe. The messages may be filtered using the subscription criterion which can be tested on each message independent of any other message. For example, a filtered published message might be “topic=Detroit Tigers & winning” for all messages related to the topic of the Detroit Tigers baseball team winning.

In a content-based system, messages are only delivered to a subscriber if the attributes or content of those messages match the constraints (subscription criterion) defined by the subscriber. The subscriber is responsible for classifying the messages.

In many publish/subscribe systems, publishers post messages to an intermediary message broker and subscribers register subscriptions with that broker, letting the broker perform the filtering.

Subscriber clients, including mobile computing clients, may use what are referred to as “macro components” in connection with the publish/subscribe system. A macro component is a bundle of components in a self-contained single object. Macro components in the context of a publish/subscribe system may be used to express events of interest to the message broker, provide the implementation to act upon those events of interest as well as provide the user interface components to convey the information of the event to the end user.

In certain computing environments, such as a mobile computing environment, the size of the display screen of the subscriber client is limited. As a result, only one message from the publish/subscribe system may be shown to the user of the subscriber client at a time. Typically, the particular message that is displayed to the user is controlled by a container, referred to as a “user interface container.” The user interface container controls the display state of the user interface of the subscriber client. The display state refers to the user interface components that are currently being used to display the content of a published message to the end user.

Traditionally, the user interface container updates the display state of the user interface upon receiving a request from the macro component to update the display state of the user interface. Each macro component may be associated with one or more events of interests. Once one of these events of interest are published, the macro component may then request the user interface container to update the display state of the user interface so that the user interface components provided by the macro component can be used to convey the received message to the end user. However, such a technique requires the macro components to use the appropriate application programming interface to communicate with the user interface container as well as to put the burden on the macro components to initiate the process in updating the display state of the user interface.

Alternatively, the user interface container may pre-load all of the macro components thereby determining which display state is associated with which macro component when a particular event is published by a publisher. However, such a process is time-consuming.

### BRIEF SUMMARY

In one embodiment of the present invention, a method for updating a display state of a user interface comprises inspecting a file containing definitions for one or more macro components, where the file comprises a listing of one or more events associated with each of the one or more macro components. The method further comprises creating an event callback function for each of the one or more macro components listed in the file to update the display state of the user interface to be a display state of a macro component in response to having one of its associated one or more events published. Additionally, the method comprises detecting an event published by the publisher. In addition, the method comprises executing, by a processor, the event callback function associated with the macro component in response to the detected event corresponding to one of its associated one or more events.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates one embodiment of the present invention of a publish/subscribe system;

FIG. 2 is a hardware configuration of a subscriber in accordance with an embodiment of the present invention;

FIG. 3 illustrates the software components of the subscriber used in connection with updating the display state of the user interface of the subscriber in accordance with an embodiment of the present invention;

FIG. 4 is a flowchart of a method for updating the display state of the user interface of the subscriber in accordance with an embodiment of the present invention;

FIG. 5 illustrates a macro component definition file in accordance with an embodiment of the present invention; and

FIG. 6 is a data structure for storing indications of macro components that are to be lazily-loaded as well as storing the events for which the lazily-loaded macro components are to be the primary receivers in accordance with an embodiment of the present invention.

### DETAILED DESCRIPTION

The present invention comprises a method, system and computer program product for updating the display state of the user interface of a subscriber client. In one embodiment of the present invention, a macro component definition file is inspected to obtain the listing of events associated with each macro component listed in the macro component definition file. An event callback function is created for each macro component listed in the macro component definition file, where the callback function will update the displayed user interface of the subscriber client to be the display state of the macro component when one its associated events is published by the publisher. Upon detecting a published event, the event callback function associated with the published event is executed thereby automatically updating the display state of the user interface of the subscriber client to be the display state of the macro component associated with the published event. In this manner, the display state of the user interface is updated without requiring the macro components to initiate the process in updating the display state of the user interface and without the user interface container incurring the time expense of pre-loading the macro components to determine which display state is associated with which macro component.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

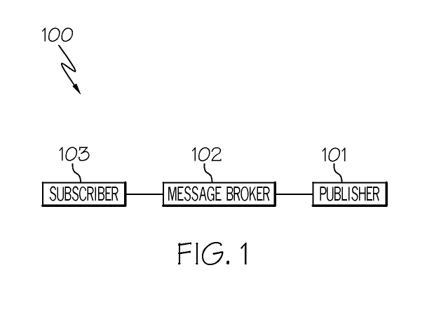

Referring now to the Figures in detail, FIG. 1 illustrates a publish/subscribe system 100 for practicing the principles of the present invention in accordance with an embodiment of the present invention. Publish/subscribe system 100 includes a publisher 101 that generates messages, also referred to as events, which contain a topic and some data content. Publisher 101 does not attempt to deliver the messages to individual users but instead delivers them to a message broker 102. Message broker 102 acts as an intermediary between publisher 101 and individual subscribers, only one subscriber 103 (also referred to herein as a “client”) being shown. Message broker 102 accepts subscriptions from individual subscribers 103 for future delivery of messages whose topic/content matches the subscription criterion.

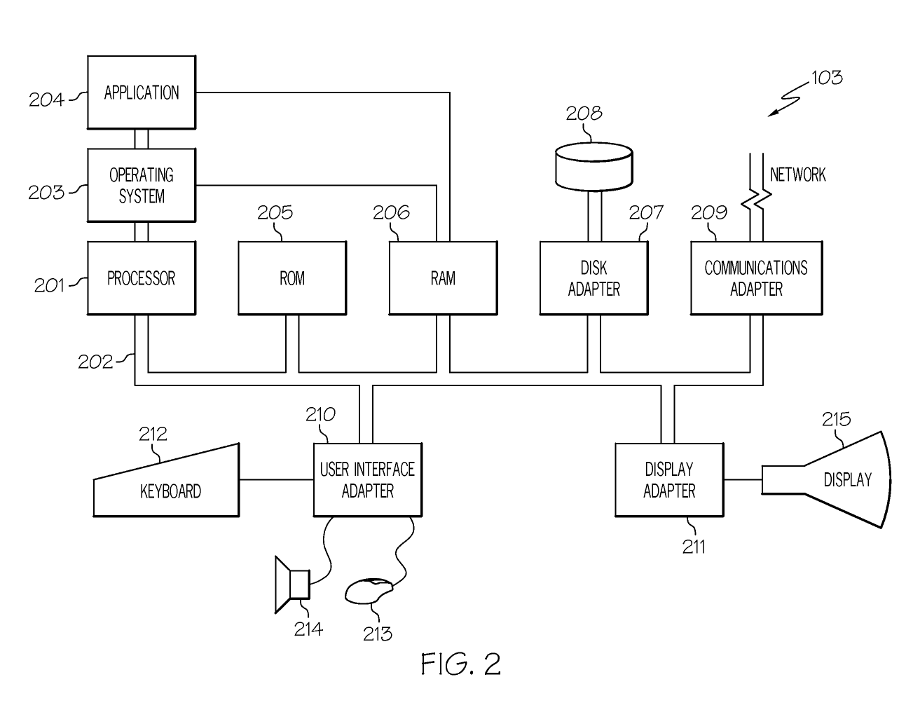

Subscriber 103 may be any type of computing device (e.g., portable computing unit, personal digital assistant (PDA), smartphone, desktop computer system, workstation, Internet appliance and the like) configured with the capability of subscribing to receive messages from one or more publishers 101. A more detailed description of the hardware configuration of an illustrative subscriber 103 is provided below in connection with FIG. 2.

Referring again to FIG. 1, publisher 101 may be a computing device, such as a server, configured to generate messages of interest to subscribers.

While FIG. 1 illustrates a single publisher 101 and a single subscriber 103, publish/subscribe system 100 may include any number of publishers 101 and subscribers 103. Furthermore, publish/subscribe system 100 is not to be limited in scope to any one particular architecture. For example, message broker 102 may reside within subscriber 103 or publisher 101. Furthermore, subscriber 103 and publisher 101 may be interconnected via a network (not shown), such as a local area network or a wide area network.

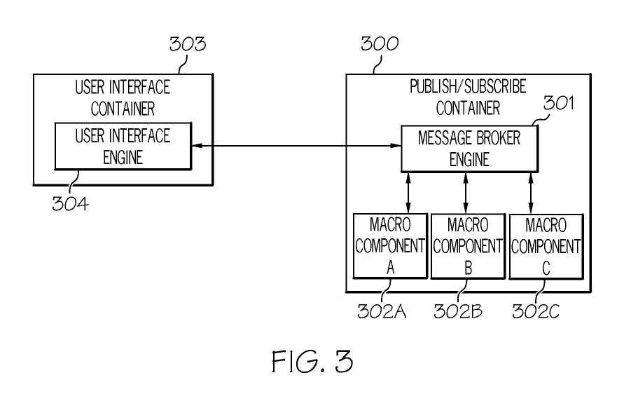

Referring now to FIG. 2, FIG. 2 illustrates a hardware configuration of subscriber 103 (FIG. 1) which is representative of a hardware environment for practicing the present invention. Referring to FIG. 2, subscriber 103 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for automatically updating the display state of the user interface of subscriber client 103, as discussed further below in association with FIGS. 3-6.

Referring again to FIG. 2, read-only memory (“ROM”) 205 is coupled to system bus 202 and includes a basic input/output system (“BIOS”) that controls certain basic functions of subscriber 103. Random access memory (“RAM”) 206 and disk adapter 207 are also coupled to system bus 202. It should be noted that software components including operating system 203 and application 204 may be loaded into RAM 206, which may be subscriber's 103 main memory for execution. Disk adapter 207 may be an integrated drive electronics (“IDE”) adapter that communicates with a disk unit 208, e.g., disk drive. It is noted that the program for automatically updating the display state of the user interface of subscriber client 103, as discussed further below in association with FIGS. 3-6, may reside in disk unit 208 or in application 204.

Subscriber 103 may further include a communications adapter 209 coupled to bus 202. Communications adapter 209 of subscriber 103 interconnects bus 202 with an outside network thereby enabling subscriber 103 to communicate with publisher 101.

I/O devices may also be connected to subscriber 103 via a user interface adapter 210 and a display adapter 211. Keyboard 212, mouse 213 and speaker 214 may all be interconnected to bus 202 through user interface adapter 210. Data may be inputted to subscriber 103 through any of these devices. A display monitor 215 may be connected to system bus 202 by display adapter 211. In this manner, a user is capable of inputting to subscriber 103 through keyboard 212 or mouse 213 and receiving output from subscriber 103 via display 215 or speaker 214.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, in certain computing environments, such as a mobile computing environment, the size of the display screen of the subscriber client is limited. As a result, only one message from the publish/subscribe system may be shown to the user of the subscriber client at a time. Typically, the particular message that is displayed to the user is controlled by a container, referred to as a “user interface container.” The user interface container controls the display state of the user interface of the subscriber client. The display state refers to the user interface components that are currently being used to display the content of a published message to the end user. Traditionally, the user interface container updates the display state of the user interface upon receiving a request from the macro component to update the display state of the user interface. However, such a technique requires the macro components to use the appropriate application programming interface to communicate with the user interface container as well as to put the burden on the macro components to initiate the process in updating the display state of the user interface. Alternatively, the user interface container may pre-load all of the macro components thereby determining which display state is associated with which macro component when a particular event is published by a publisher. However, such a process is time-consuming.

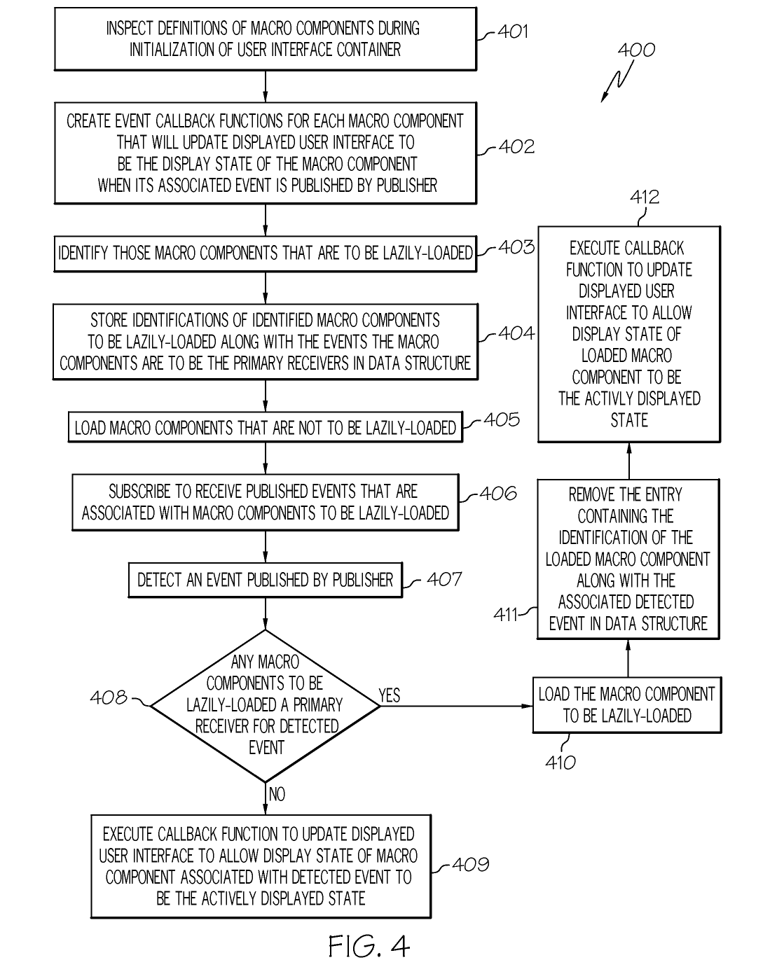

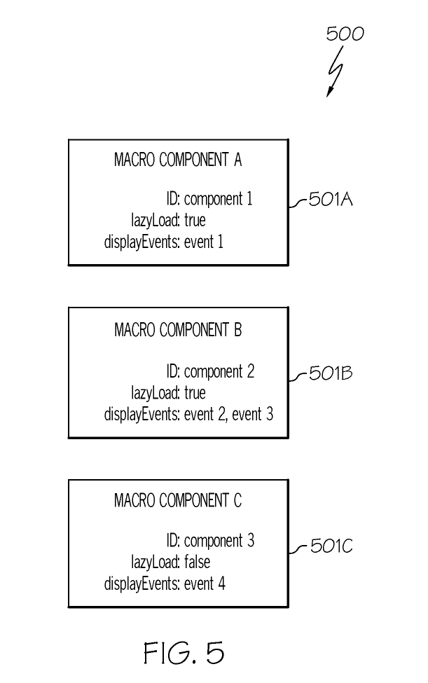

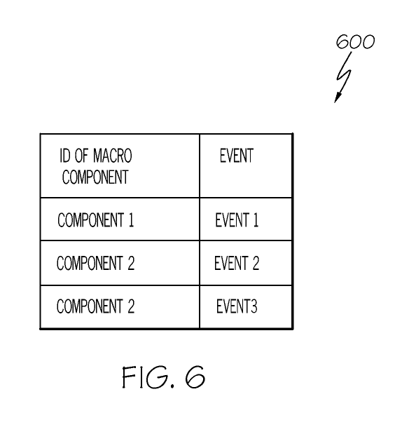

The principles of the present invention provide a means for updating the display state of the user interface of the subscriber without requiring the macro components to initiate the process in updating the display state of the user interface and without the user interface container incurring the time expense of pre-loading the macro components to determine which display state is associated with which macro component as discussed below in connection with FIGS. 3-6. FIG. 3 illustrates the software components of subscriber 103 (FIGS. 1 and 2) used in connection with updating the display state of the user interface of subscriber client 103. FIG. 4 is a flowchart of a method for updating the display state of the user interface of subscriber client 103. FIG. 5 illustrates a macro component definition file. FIG. 6 illustrates a data structure for storing indications of macro components that are to be lazily-loaded along with their associated events.

Referring to FIG. 3, as stated above, FIG. 3 illustrates the software components of subscriber 103 (FIGS. 1 and 2) used in connection with updating the display state of the user interface of subscriber client 103 in accordance with an embodiment of the present invention. In one embodiment, these software components are the components of the program for updating the display state of the user interface of subscriber client 103, where the program may reside in application 204 (FIG. 2).

The following provides a brief description of these software components. A more detailed description of these software components is provided below in conjunction with FIGS. 4-6.

Referring again to FIG. 3, a container 300, referred to herein as the “publish/subscribe container,” may include a message broker engine 301. Message broker engine 301 may include all or a portion of the functionality of message broker 102 depicted in FIG. 1. Container 300 further includes macro components 302A-302C (identified as macro components A, B and C, respectively) configured to communicate with message broker engine 301. Macro components 302A-302C may collectively or individually be referred to as macro components 302 or macro component 302, respectively. Container 300 may include any number of macro components 302.

Each macro component 302 is a bundle of components in a self-contained object. In the context of the publish/subscribe system, each macro component 302 may be used to express events of interest to message broker engine 301, provide the implementation to act upon those events of interest as well as provide the user interface components to convey the information of the event to the end user.

Furthermore, FIG. 3 illustrates a container 303, referred to herein as the “user interface container.” User interface container 303 is configured to control the display state of the user interface of subscriber client 103. The display state refers to the user interface components that are currently being used to display the content of a published message to the end user.

User interface container 303 includes a user interface engine 304 configured to communicate with message broker engine 301. User interface engine 304 is configured to update the display state of the user interface of subscriber 103 as discussed below in connection with FIG. 4.

FIG. 4 is a flowchart of a method 400 for updating the display state of the user interface of subscriber client 103 (FIGS. 1 and 2) in accordance with an embodiment of the present invention.

Referring to FIG. 4, in conjunction with FIGS. 1-3, in step 401, user interface engine 304 inspects the definitions of the macro components in a macro component definition file during initialization of user interface container 303. In one embodiment, the macro component definition file specifies whether the macro component is to be lazily-loaded as well as which events the macro component is to be the primary receiver. Lazy loading refers to deferring the loading of the macro component until the object is needed in order to increase the efficiency in the program's operation. A macro component may be deemed to be the primary receiver if the macro component is the primary display component for the targeted event/logical channel. That is, a macro component may be deemed to be the primary receiver if the macro component is to be the primary recipient of the data from the published event. An example of a macro component definition file is shown in FIG. 5.

Referring to FIG. 5, FIG. 5 illustrates a macro component definition file 500 in accordance with an embodiment of the present invention. Macro component definition file 500 may include records/files for each macro component 302. For example, macro component definition file 500 includes a record 501A for macro component 302A. Similarly, macro component definition file 500 includes a record 501B for macro component 302B and a record 501C for macro component 302C. Records 501A-501C may collectively or individually be referred to as records 501 or record 501, respectively.

Each record 501 includes information relating to the identification (identified by “ID”) of macro component 302, whether the macro component 302 is to be lazily-loaded (identified by “lazyLoad”) and the events for which the macro component 302 is to be the primary receiver (identified by “displayEvents”). As shown in FIG. 5, record 501A of macro component 302A indicates that its identification is “component 1,” that it will be lazily-loaded and that it is the primary receiver for the event identified as “event 1.” Similarly, record 501B of macro component 302B indicates that its identification is “component 2,” that it will be lazily-loaded and that it is the primary receiver for the events identified as “event 2” and “event 3.” Record 501C of macro component 302C indicates that its identification is “component 3,” that it will not be lazily-loaded and that it is the primary receiver for the event identified as “event 4.”

In one embodiment, macro component definition file 500 resides in the memory (e.g., memory 206), disk unit 208 or cache (not shown in FIG. 2) (e.g., CPU cache, disk cache) of subscriber 103. Macro component definition file 500 may store any number of component definitions and macro component definition file 500 is not to be limited in scope to the depiction of FIG. 5.

Returning to FIG. 4, in conjunction with FIGS. 1-3 and 5, in step 402, user interface engine 304 creates callback functions for each macro component identified in macro component definition file 500 that will update the displayed user interface of subscriber client 103 to be the display state of macro component 302 when its associated event is published by publisher 101. Each callback function may be associated with the event/logical channel that is associated with each macro component listed in macro component definition file 500. For example, referring to FIG. 5, a callback function may be associated with “event 4” which is associated with macro component 302C. In another example, a callback function may be associated with “event 1” which is associated with macro component 302A.

In step 403, user interface engine 304 identifies those macro components 302 in macro component definition file 500 that are to be lazily-loaded. For example, referring to FIG. 5, user interface engine 304 would identify macro components 302A, 302B to be lazily-loaded.

In step 404, user interface engine 304 stores the identifications of macro components 302 identified to be lazily-loaded along with the events they are to be the primary receivers in a data structure as illustrated in FIG. 6.

Referring to FIG. 6, FIG. 6 illustrates a data structure 600 for storing indications of macro components 302 that are to be lazily-loaded as well as the events for which macro components 302 are to the primary receivers. For example, referring to FIG. 6, in conjunction with FIG. 5, the identification of macro components 302A, 302B (“component 1,” “component 2”) along with their events (“Event 1,” “Event 2,” “Event 3”) for which they are to be the primary receivers are stored in data structure 600 since they were indicated as being lazily-loaded in macro component definition file 500. In one embodiment, data structure 600 resides in the memory (e.g., memory 206), disk unit 208 or cache (not shown in FIG. 2) (e.g., CPU cache, disk cache) of subscriber 103. Data structure 600 may store any number of identifiers and events and data structure 600 is not to be limited in scope to the depiction of FIG. 6.

Returning to FIG. 4, in conjunction with FIGS. 1-3 and 5-6, in step 405, user interface engine 304 loads macro components 302 that are not to be lazily-loaded. For example, referring to FIG. 5, macro component 302C is not to be lazily-loaded.

In step 406, user interface engine 304 subscribes with message broker engine 301 to receive published events that are associated with macro components 302 to be lazily-loaded. For instance, referring to FIGS. 5 and 6, user interface engine 304 would subscribe with message broker engine 301 to receive published events, Event 1, Event 2 and Event 3. That is, user interface engine 304 subscribes to the logical channels of the events for which macro components 302 to be lazily-loaded are the primary receivers.

In step 407, user interface engine 304 detects an event published by publisher 101.

In step 408, a determination is made by user interface engine 304 as to whether any macro component 302 to be lazily-loaded is a primary receiver for the detected event. In one embodiment, user interface engine 304 determines whether any macro component 302 to be lazily-loaded is a primary receiver for the detected event by performing a table-lookup of data structure 600 to identify an event that matches the detected event. For example, if user interface engine 304 detected “Event 1,” then user interface engine 304 would identify that event in data structure 600 as being associated with “component 1” which is the identification of macro component 302A. In this manner, user interface engine 304 may identify the particular macro component 302 to be lazily-loaded that is the primary receiver of a detected event. If, however, user interface engine 304 does not identify an event in data structure 600 that matches the detected event, then there are no macro components 302 to be lazily-loaded that are a primary receiver of the detected event.

If user interface engine 304 does not identify a macro component 302 to be lazily-loaded as being a primary receiver of the detected event, then, in step 409, user interface engine 304 executes the callback function associated with the detected event (event detected in step 407) for the non-lazily loaded macro component (previously loaded in step 405) to update the displayed user interface to allow the display state of the loaded macro component 302 to be the actively displayed state.

If, however, user interface engine 304 identifies a macro component 302 to be lazily-loaded that is a primary receiver of the detected event, then, in step 410, user interface engine 304 loads said macro component 302 to be lazily-loaded.

In step 411, user interface engine 304 removes the entry containing the identification of macro component 302 (macro component 302 loaded in step 410) along with the associated detected event in data structure 600.

In step 412, user interface engine 304 executes the callback function associated with the lazily-loaded macro component to update the displayed user interface to allow the display state of the loaded macro component 302 to be the actively displayed state.

In this manner, the display state of the user interface is updated without requiring the macro components to initiate the process in updating the display state of the user interface and without the user interface container incurring the time expense of pre-loading the macro components to determine which display state is associated with which macro component.

In some implementations, method 400 may include other and/or additional steps that, for clarity, are not depicted. Further, in some implementations, method 400 may be executed in a different order presented and that the order presented in the discussion of FIG. 4 is illustrative. Additionally, in some implementations, certain steps in method 400 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1. A method for updating a display state of a user interface, the method comprising:
inspecting a file containing definitions for one or more macro components, wherein said file comprises a listing of one or more events associated with each of said one or more macro components;
creating an event callback function for each of said one or more macro components listed in said file to update said display state of said user interface to be a display state of a macro component in response to having one of its associated one or more events published;
detecting an event published by said publisher; and
executing, by a processor, said event callback function associated with said macro component in response to said detected event corresponding to said one of its associated one or more events.

2. The method as recited in claim 1, wherein said file comprises information regarding whether said one or more macro components are to be lazily-loaded and which events said one or more macro components are to be a primary receiver.

3. The method as recited in claim 2 further comprising:
identifying a macro component in said file to be lazily-loaded; and
storing an indication of said identified macro component to be lazily-loaded along with one or more events said identified macro component is to be a primary receiver in a data structure.

4. The method as recited in claim 3 further comprising:
subscribing to receive said one or more events said identified macro component is to be a primary receiver.

5. The method as recited in claim 4 further comprising:
detecting one of said one or more subscribed events published by said publisher.

6. The method as recited in claim 5 further comprising:
executing said event callback function associated with said identified macro component in response to detecting said one of said one or more subscribed events.

7. The method as recited in claim 5 further comprising:
loading said identified macro component to be lazily-loaded in response to detecting said one of said one or more subscribed events.

8. The method as recited in claim 7 further comprising:
removing an entry from said data structure storing said indication of said identified macro component along with said detected subscribed event in response to detecting said one of said one or more subscribed events.

9. A computer program product embodied in a computer readable storage medium for updating a display state of a user interface, the computer program product comprising the programming instructions for:
inspecting a file containing definitions for one or more macro components, wherein said file comprises a listing of one or more events associated with each of said one or more macro components;
creating an event callback function for each of said one or more macro components listed in said file to update said display state of said user interface to be a display state of a macro component in response to having one of its associated one or more events published;
detecting an event published by said publisher; and
executing said event callback function associated with said macro component in response to said detected event corresponding to said one of its associated one or more events.

10. The computer program product as recited in claim 9, wherein said file comprises information regarding whether said one or more macro components are to be lazily-loaded and which events said one or more macro components are to be a primary receiver.

11. The computer program product as recited in claim 10 further comprising the programming instructions for:
identifying a macro component in said file to be lazily-loaded; and
storing an indication of said identified macro component to be lazily-loaded along with one or more events said identified macro component is to be a primary receiver in a data structure.

12. The computer program product as recited in claim 11 further comprising the programming instructions for:
subscribing to receive said one or more events said identified macro component is to be a primary receiver.

13. The computer program product as recited in claim 12 further comprising the programming instructions for:
detecting one of said one or more subscribed events published by said publisher.

14. The computer program product as recited in claim 13 further comprising the programming instructions for:
executing said event callback function associated with said identified macro component in response to detecting said one of said one or more subscribed events.

15. The computer program product as recited in claim 13 further comprising the programming instructions for:
loading said identified macro component to be lazily-loaded in response to detecting said one of said one or more subscribed events.

16. The computer program product as recited in claim 15 further comprising the programming instructions for:
removing an entry from said data structure storing said indication of said identified macro component along with said detected subscribed event in response to detecting said one of said one or more subscribed events.

17. A system, comprising:
a memory unit for storing a computer program for updating a display state of a user interface; and
a processor coupled to said memory unit, wherein said processor, responsive to said computer program, comprises
circuitry for inspecting a file containing definitions for one or more macro components, wherein said file comprises a listing of one or more events associated with each of said one or more macro components;
circuitry for creating an event callback function for each of said one or more macro components listed in said file to update said display state of said user interface to be a display state of a macro component in response to having one of its associated one or more events published;
circuitry for detecting an event published by said publisher; and
circuitry for executing said event callback function associated with said macro component in response to said detected event corresponding to said one of its associated one or more events.

18. The system as recited in claim 17, wherein said file comprises information regarding whether said one or more macro components are to be lazily-loaded and which events said one or more macro components are to be a primary receiver.

19. The system as recited in claim 18, wherein said processor further comprises:
circuitry for identifying a macro component in said file to be lazily-loaded; and
circuitry for storing an indication of said identified macro component to be lazily-loaded along with one or more events said identified macro component is to be a primary receiver in a data structure.

20. The system as recited in claim 19, wherein said processor further comprises:
circuitry for subscribing to receive said one or more events said identified macro component is to be a primary receiver.

21. The system as recited in claim 20, wherein said processor further comprises:
circuitry for detecting one of said one or more subscribed events published by said publisher.

22. The system as recited in claim 21, wherein said processor further comprises:
circuitry for executing said event callback function associated with said identified macro component in response to detecting said one of said one or more subscribed events.

23. The system as recited in claim 21, wherein said processor further comprises:
circuitry for loading said identified macro component to be lazily-loaded in response to detecting said one of said one or more subscribed events.

24. The system as recited in claim 23, wherein said processor further comprises:
circuitry for removing an entry from said data structure storing said indication of said identified macro component along with said detected subscribed event in response to detecting said one of said one or more subscribed events.
